(19) United States
(12) Patent Application Publication
(10) Pub. No.: US 2026/0211353 A1
(43) Pub. Date: Jul. 23, 2026

(54) IMAGE FORMING UNIT, PROCESS CARTRIDGE, AND IMAGE FORMING APPARATUS

(71) Applicant: FUJIFILM Business Innovation Corp., Tokyo (JP)

(72) Inventors: Yukimi KAWABATA, Kanagawa (JP); Takuya YAMAMOTO, Kanagawa (JP)

(73) Assignee: FUJIFILM Business Innovation Corp., Tokyo (JP)

(21) Appl. No.: 19/303,293

(22) Filed: Aug. 18, 2025

(30) Foreign Application Priority Data
Jan. 22, 2025 (JP) 2025-009444

(51) Int. Cl. G03G 15/02; G03G 5/047; G03G 21/18

(52) U.S. Cl. CPC G03G 15/0233; G03G 5/047; G03G 21/1814; G03G 2215/021

(57) ABSTRACT

An image forming unit includes a photoreceptor and a charging member that comes into contact with a surface of the photoreceptor to charge the photoreceptor, in which the photoreceptor includes a conductive substrate and a lamination-type photosensitive layer that has a charge generation layer and a charge transport layer disposed on the conductive substrate, the charge transport layer contains a polyarylate resin and does not substantially contain an organic fluorine compound, the charging member includes a support member, an elastic layer disposed on the support member, and a surface layer disposed on the elastic layer, and the surface layer contains a resin, conductive particles, and a silicon compound, and a silicon element concentration on a surface of the surface layer is 0.2 atm % or more and 1.2 atm % or less.

### CROSS-REFERENCE TO RELATED APPLICATIONS

This application is based on and claims priority under 35 USC 119 from Japanese Patent Application No. 2025-009444 filed Jan. 22, 2025.

### BACKGROUND

### (i) Technical Field

The present disclosure relates to an image forming unit, a process cartridge, and an image forming apparatus.

### (ii) Related Art

JP2023-121553A discloses an image forming unit including a photoreceptor and a contact-type charging member, in which a charge transport layer of the photoreceptor contains at least one of a polyester resin having a constitutional unit having an aromatic ring or a polycarbonate resin having a constitutional unit having an aromatic ring, and a storage elastic modulus G′ of an elastic layer of the contact-type charging member is 5.0 MPa or less.

JP2023-134202A discloses an example in which a conductive member containing a polyether-modified polydimethylsiloxane in a surface layer is applied onto a contact-type charging roll.

### SUMMARY

Aspects of non-limiting embodiments of the present disclosure relate to an image forming unit in which fogging is unlikely to occur in an image in a low-temperature and low-humidity environment and streak-like density unevenness is unlikely to occur in the image.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming unit including a photoreceptor and a charging member that comes into contact with a surface of the photoreceptor to charge the photoreceptor, in which the photoreceptor includes a conductive substrate and a lamination-type photosensitive layer that has a charge generation layer and a charge transport layer disposed on the conductive substrate, the charge transport layer contains a polyarylate resin and does not substantially contain an organic fluorine compound, the charging member includes a support member, an elastic layer disposed on the support member, and a surface layer disposed on the elastic layer, and the surface layer contains a resin, conductive particles, and a silicon compound, and a silicon element concentration on a surface of the surface layer is 0.2 atm % or more and 1.2 atm % or less.

### BRIEF DESCRIPTION OF THE DRAWINGS

Exemplary embodiment(s) of the present invention will be described in detail based on the following figures, wherein:

FIG. 1 is a partial cross-sectional view showing an example of a layer configuration of a photoreceptor included in an image forming unit according to the present disclosure;

FIG. 2 is a schematic perspective view showing an example of a charging member included in the image forming unit according to the present disclosure;

FIG. 3 is a schematic cross-sectional view showing the example of the charging member included in the image forming unit according to the present disclosure, and is a cross-sectional view taken along a line A-A of FIG. 2;

FIG. 4 is a schematic configuration view showing an example of an image forming apparatus according to the present disclosure; and

FIG. 5 is a schematic configuration view showing another example of the image forming apparatus according to the present disclosure.

### DETAILED DESCRIPTION

The exemplary embodiments of the present disclosure will be described below. The following descriptions and examples merely illustrate the exemplary embodiments, and do not limit the scope of the exemplary embodiments.

In the present disclosure, “A and/or B” is synonymous with “at least one of A or B”. That is, “A and/or B” represents that A alone may be used, B alone may be used, or a combination of A and B may be used.

In the present disclosure, a numerical range described using “to” represents a range including numerical values listed before and after “to” as the minimum value and the maximum value respectively.

Regarding the numerical ranges described in stages in the present disclosure, the upper limit or lower limit of a numerical range may be replaced with the upper limit or lower limit of another numerical range described in stages. Furthermore, in the present disclosure, the upper limit or lower limit of a numerical range may be replaced with values described in examples.

In the present disclosure, the term “step” includes not only an independent step but a step that is not clearly distinguished from other steps as long as the purpose of the step is achieved.

In the present disclosure, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present disclosure, each component may include a plurality of corresponding substances. In a case where the amount of each component in a composition is mentioned in the present disclosure, and there are two or more kinds of substances corresponding to each component in the composition, unless otherwise specified, the amount of each component means the total amount of two or more kinds of the substances present in the composition.

In the present disclosure, each component may include two or more kinds of corresponding particles. In a case where there are two or more kinds of particles corresponding to each component in a composition, unless otherwise specified, the particle size of each component means a value for a mixture of two or more kinds of the particles present in the composition.

In the present disclosure, “axial direction” of a charging member means a direction in which a rotation axis of the charging member extends, and “circumferential direction” of the charging member means a rotation direction of the charging member.

In the present disclosure, in a case where a lamination relationship of layers constituting the charging member is expressed by “upper layer” and “lower layer”, a layer close to a photoreceptor is referred to as the “upper layer”, and a layer far from the photoreceptor is referred to as the “lower layer”.

### Image Forming Unit

The image forming unit according to the present disclosure includes a photoreceptor and a charging member (so-called contact-type charging member) that comes into contact with a surface of the photoreceptor to charge the photoreceptor.

The photoreceptor included in the image forming unit according to the present disclosure includes a conductive substrate and a lamination-type photosensitive layer having a charge generation layer and a charge transport layer disposed on the conductive substrate, in which the charge transport layer contains a polyarylate resin and does not substantially contain an organic fluorine compound.

The charging member included in the image forming unit according to the present disclosure includes a support member, an elastic layer disposed on the support member, and a surface layer disposed on the elastic layer, in which the surface layer contains a resin, conductive particles, and a silicon compound, and a silicon element concentration on a surface of the surface layer is 0.2 atm % or more and 1.2 atm % or less.

In the image forming unit according to the present disclosure, fogging is unlikely to occur in an image in a low-temperature and low-humidity environment and streak-like density unevenness is unlikely to occur in the image.

The surface of the surface layer in the charging member is a surface in contact with the photoreceptor.

In a case where the silicon element concentration of the surface of the surface layer in the charging member is less than 0.2 atm %, the ten-point average roughness RzJIS (JIS B 0601:2013) of the outer peripheral surface of the charging member is increased, so that a surface resistance is increased, and thus fogging is likely to occur in an image in a low-temperature and low-humidity environment. From the viewpoint of suppressing the event, the silicon element concentration of the surface of the surface layer in the charging member is 0.2 atm % or more, and for example, more preferably 0.3 atm % or more.

In a case where the silicon element concentration of the surface of the surface layer in the charging member is more than 1.2 atm %, the photoreceptor is easily in contact with the charging member, and thus streak-like density unevenness is likely to occur in the image. From the viewpoint of suppressing the event, the silicon element concentration of the surface of the surface layer in the charging member is 1.2 atm % or less, and for example, more preferably 1.1 atm % or less and still more preferably 1.0 atm % or less.

The silicon element concentration of the surface of the surface layer in the charging member is, for example, particularly preferably 0.3 atm % or more and 1.0 atm % or less.

Hereinafter, the photoreceptor and the charging member will each be described in detail.

### Photoreceptor

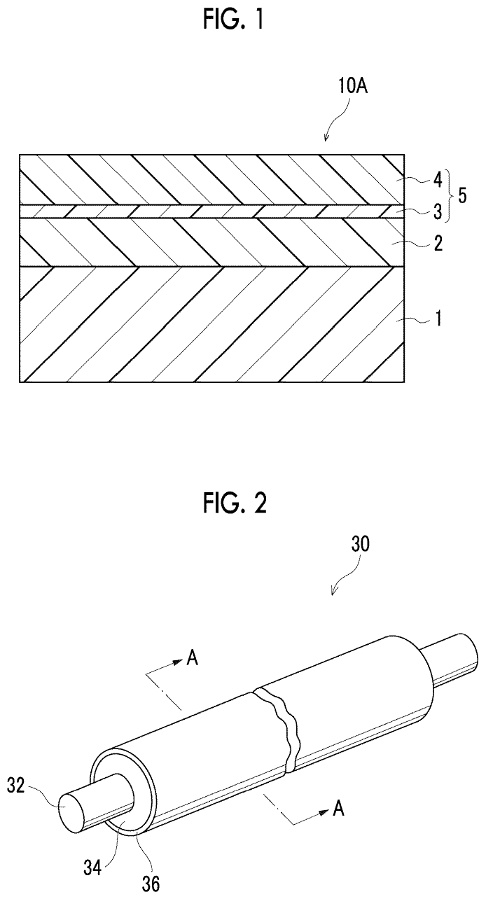

FIG. 1 is a partial cross-sectional view schematically showing an example of the layer configuration of the photoreceptor. A photoreceptor 10A shown in FIG. 1 has a structure in which an undercoat layer 2, a charge generation layer 3, and a charge transport layer 4 are laminated in this order on a conductive substrate 1, and the charge generation layer 3 and the charge transport layer 4 constitute a photosensitive layer 5 (lamination-type photosensitive layer). The undercoat layer 2 may or may not be provided. The photoreceptor 10A may include an interlayer (not shown) between the undercoat layer 2 and the charge generation layer 3.

The charge transport layer of the photoreceptor contains a polyarylate resin. In the polyarylate resin, resin molecules are bonded to each other by an intermolecular force due to stacking of aromatic rings, and thus abrasion resistance of the charge transport layer is improved. As the polyarylate resin, for example, a polycondensate of bisphenols and an aromatic divalent carboxylic acid is preferable.

The charge transport layer of the photoreceptor does not substantially contain an organic fluorine compound. In a case where the charge transport layer contains an organic fluorine compound, the charge of the layer tends to decrease from the expected value, and thus the streak-like density unevenness is likely to occur in the image.

Examples of the organic fluorine compound include polytetrafluoroethylene, a polyvinylidene fluoride-based resin, a fluorine-based rubber, a fluorine-based graft polymer, and a fluorine-based surfactant.

The expression that the charge transport layer does not substantially contain an organic fluorine compound means that a mass proportion of the organic fluorine compound in the total mass of the charge transport layer is 1% by mass or less.

For example, the mass proportion of the organic fluorine compound in the total mass of the charge transport layer is preferably smaller, and for example, the mass proportion is preferably 0.5% by mass or less, more preferably 0.1% by mass or less, and particularly preferably 0% by mass. That is, for example, it is particularly preferable that the charge transport layer does not contain an organic fluorine compound.

### Conductive Substrate

Examples of the conductive substrate include metal plates, metal drums, metal belts, or the like, containing a metal (such as aluminum, copper, zinc, chromium, nickel, molybdenum, vanadium, indium, gold, and platinum) or an alloy (such as stainless steel). In addition, examples of the conductive substrate also include paper, a resin film, a belt, or the like, that is obtained by being coated, vapor-deposited, or laminated with a conductive compound (such as a conductive polymer and indium oxide), a metal (such as aluminum, palladium, and gold) or an alloy. Here, the term “conductive” denotes that a volume resistivity is less than 1×10¹³ Ω·cm.

In a case where the electrophotographic photoreceptor is used in a laser printer, for example, it is preferable that a surface of the conductive substrate is roughened such that a centerline average roughness Ra thereof is 0.04 μm or more and 0.5 μm or less for the purpose of suppressing interference fringes from occurring in a case of irradiation with laser beams. In a case where incoherent light is used as a light source, roughening of the surface to prevent the interference fringes is not particularly necessary, and it is appropriate for longer life because occurrence of defects due to the roughness of the surface of the conductive substrate is suppressed.

Examples of the roughening method include wet honing performed by suspending an abrasive in water and spraying the suspension to the conductive substrate, centerless grinding performed by pressure-welding the conductive substrate against a rotating grindstone and continuously grinding the conductive substrate, and an anodizing treatment.

Examples of the roughening method also include a method of dispersing conductive or semi-conductive powder in a resin without roughening the surface of the conductive substrate to form a layer on the surface of the conductive substrate, and performing roughening using the particles dispersed in the layer.

The roughening treatment by anodization is a treatment of forming an oxide film on the surface of the conductive substrate by carrying out anodization in an electrolytic solution using a conductive substrate made of a metal (for example, aluminum) as an anode. Examples of the electrolytic solution include a sulfuric acid solution and an oxalic acid solution. However, a porous anodized film formed by the anodization is chemically active in a natural state, is easily contaminated, and has a large resistance fluctuation depending on the environment. Therefore, for example, it is preferable that a sealing treatment is performed on the porous anodized film so that micropores of the oxide film are closed by volume expansion due to a hydration reaction in pressurized steam or boiling water (a metal salt such as nickel may be added thereto) for a change into a more stable a hydrous oxide.

A film thickness of the anodized film is, for example, preferably 0.3 μm or more and 15 μm or less. In a case where the film thickness is within the above-described range, barrier properties against injection tend to be exhibited, and an increase in the residual potential due to repeated use tends to be suppressed.

The conductive substrate may be subjected to a treatment with an acidic treatment liquid or a boehmite treatment.

The treatment with an acidic treatment liquid is carried out, for example, as follows. First, an acidic treatment liquid containing phosphoric acid, chromic acid, and hydrofluoric acid is prepared. As a blending proportion of the phosphoric acid, chromic acid, and hydrofluoric acid to the acidic treatment liquid, for example, a concentration of the phosphoric acid may be in a range of 10% by mass or more and 11% by mass or less, a concentration of the chromic acid may be in a range of 3% by mass or more and 5% by mass or less, and a concentration of the hydrofluoric acid may be in a range of 0.5% by mass or more and 2% by mass or less, and a concentration of all of these acids may be in a range of 13.5% by mass or more and 18% by mass or less. A treatment temperature is, for example, preferably 42° C. or higher and 48° C. or lower. A film thickness of the coating film is, for example, preferably 0.3 μm or more and 15 μm or less.

The boehmite treatment is carried out, for example, by dipping the base material in pure water at 90° C. or higher and 100° C. or lower for 5 minutes to 60 minutes, or by bringing the base material into contact with heated steam at 90° C. or higher and 120° C. or lower for 5 minutes to 60 minutes. A film thickness of the coating film is, for example, preferably 0.1 μm or more and 5 μm or less. The coating film may be further subjected to an anodizing treatment using an electrolytic solution having low film solubility, such as adipic acid, boric acid, a borate, a phosphate, a phthalate, a maleate, a benzoate, a tartrate, or a citrate.

### Undercoat Layer

The undercoat layer is, for example, a layer containing inorganic particles and a binder resin.

Examples of the inorganic particles include inorganic particles having a powder resistance (volume resistivity) of 1×10² Ω·cm or more and 1×10¹¹ Ω·cm or less.

Among the above, as the inorganic particles having the above-described resistance value, for example, metal oxide particles such as tin oxide particles, titanium oxide particles, zinc oxide particles, and zirconium oxide particles may be used, and zinc oxide particles are particularly preferable.

A specific surface area of the inorganic particles, measured by a BET method, may be, for example, 10 m²/g or more.

A volume-average particle diameter of the inorganic particles may be 50 nm or more and 2,000 nm or less (for example, preferably 60 nm or more and 1,000 nm or less).

A content of the inorganic particles is, for example, preferably 10% by mass or more and 80% by mass or less, and more preferably 40% by mass or more and 80% by mass or less with respect to the binder resin.

The inorganic particles may be subjected to a surface treatment. As the inorganic particles, two or more kinds of inorganic particles subjected to different surface treatments or two or more kinds of inorganic particles having different particle diameters may be used in a form of a mixture.

Examples of a surface treatment agent include a silane coupling agent, a titanate-based coupling agent, an aluminum-based coupling agent, and a surfactant. In particular, for example, a silane coupling agent is preferable, and a silane coupling agent having an amino group is more preferable.

Examples of the silane coupling agent having an amino group include 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane; but the present disclosure is not limited thereto.

The silane coupling agent may be used in a form of a mixture of two or more kinds thereof. For example, the silane coupling agent having an amino group and other silane coupling agents may be used in combination. Examples of the other silane coupling agents include vinyltrimethoxysilane, 3-methacryloxypropyl-tris(2-methoxyethoxy) silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane; but the present disclosure is not limited thereto.

A surface treatment method using the surface treatment agent may be any method as long as the method is a known method, and any of a dry method or a wet method may be used.

A treatment amount of the surface treatment agent is, for example, preferably 0.5% by mass or more and 10% by mass or less with respect to the inorganic particles.

Here, for example, the undercoat layer may contain an electron-accepting compound (acceptor compound) together with the inorganic particles from the viewpoint of enhancing long-term stability of electrical properties and carrier blocking properties.

Examples of the electron-accepting compound include electron-transporting substances, for example, a compound having an anthraquinone structure; a quinone-based compound such as chloranil and bromanil; a tetracyanoquinodimethane-based compound; a fluorenone compound such as 2,4,7-trinitrofluorenone and 2,4,5,7-tetranitro-9-fluorenone; an oxadiazole-based compound such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; a xanthone-based compound; a thiophene compound; a diphenoquinone compound such as 3,3′,5,5′-tetra-t-butyldiphenoquinone; and a benzophenone compound such as 4-hydroxybenzophenone and 2,3,4-trihydroxybenzophenone.

In particular, as the electron-accepting compound, for example, a compound having an anthraquinone structure is preferable. As the compound having an anthraquinone structure, for example, a hydroxyanthraquinone compound, an aminoanthraquinone compound, or an aminohydroxyanthraquinone compound is preferable; and specifically, anthraquinone, alizarin, quinizarin, anthrarufin, purpurin, 4-ethoxy-1,2-hydroxy-9,10-anthraquinone, or a derivative thereof is preferable.

The electron-accepting compound may be contained in the undercoat layer in a state of being dispersed with the inorganic particles, or in a state of being attached to the surface of the inorganic particles.

Examples of a method of attaching the electron-accepting compound to the surface of the inorganic particles include a dry method and a wet method.

The dry method is, for example, a method of attaching the electron-accepting compound to the surface of the inorganic particles by adding the electron-accepting compound dropwise to the inorganic particles directly or by dissolving the electron-accepting compound in an organic solvent while stirring the inorganic particles with a mixer having a large shearing force and spraying the mixture together with dry air or nitrogen gas. For example, the dropwise addition or spraying of the electron-accepting compound may be performed at a temperature equal to or lower than a boiling point of the solvent. After the dropwise addition or spraying of the electron-accepting compound, the mixture may be further baked at 100° C. or higher. The baking is not particularly limited as long as the temperature and the time are adjusted such that electrophotographic characteristics can be obtained.

The wet method is, for example, a method of attaching the electron-accepting compound to the surface of the inorganic particles by adding the electron-accepting compound to inorganic particles while dispersing the inorganic particles in a solvent by performing using a stirrer, an ultrasonic disperser, a sand mill, an attritor, or a ball mill, stirring or dispersing the mixture, and removing the solvent. The solvent removing method is carried out by, for example, filtration or distillation so that the solvent is distilled off. After removal of the solvent, the mixture may be further baked at 100° C. or higher. The baking is not particularly limited as long as the temperature and the time are adjusted such that electrophotographic characteristics can be obtained. In the wet method, the moisture contained in the inorganic particles may be removed before the electron-accepting compound is added, and examples thereof include a method of removing the moisture while stirring and heating the inorganic particles in a solvent and a method of removing the moisture by azeotropically boiling the inorganic particles with a solvent.

The electron-accepting compound may be attached before or after the inorganic particles are subjected to the surface treatment with the surface treatment agent or simultaneously with the surface treatment with the surface treatment agent.

A content of the electron-accepting compound may be, for example, 0.01% by mass or more and 20% by mass or less, preferably 0.01% by mass or more and 10% by mass or less with respect to the inorganic particles.

Examples of the binder resin used for the undercoat layer include a known polymer compound such as an acetal resin (such as polyvinyl butyral), a polyvinyl alcohol resin, a polyvinyl acetal resin, a casein resin, a polyamide resin, a cellulose resin, gelatin, a polyester resin, an unsaturated polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a urea resin, a phenol resin, a phenol-formaldehyde resin, a melamine resin, a urethane resin, an alkyd resin, and an epoxy resin; a zirconium chelate compound; a titanium chelate compound; an aluminum chelate compound; a titanium alkoxide compound; an organic titanium compound; and a known material such as a silane coupling agent.

Examples of the binder resin used for the undercoat layer also include a charge-transporting resin having a charge-transporting group, and a conductive resin (for example, polyaniline or the like).

Among the above, as the binder resin used for the undercoat layer, for example, a resin insoluble in a coating solvent of an upper layer is suitable; and a resin obtained by a reaction between at least one resin selected from the group consisting of a thermosetting resin such as a urea resin, a phenol resin, a phenol-formaldehyde resin, a melamine resin, a urethane resin, an unsaturated polyester resin, an alkyd resin, or an epoxy resin; a polyamide resin, a polyester resin, a polyether resin, a methacrylic resin, an acrylic resin, a polyvinyl alcohol resin, and a polyvinyl acetal resin, and a curing agent is particularly suitable.

In a case where these binder resins are used in combination of two or more kinds thereof, a mixing proportion thereof is set as necessary.

The undercoat layer may contain various additives for improving the electrical properties, the environmental stability, and the image quality.

Examples of the additive include known materials, for example, an electron-transporting pigment such as a polycyclic condensed pigment or an azo-based pigment, a zirconium chelate compound, a titanium chelate compound, an aluminum chelate compound, a titanium alkoxide compound, an organic titanium compound, and a silane coupling agent. The silane coupling agent is used for the surface treatment of the inorganic particles as described above, but may be further added to the undercoat layer as the additive.

Examples of the silane coupling agent as the additive include vinyltrimethoxysilane, 3-methacryloxypropyl-tris(2-methoxyethoxy) silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compound include zirconium butoxide, ethyl zirconium acetoacetate, zirconium triethanolamine, acetylacetonate zirconium butoxide, ethyl zirconium butoxide acetoacetate, zirconium acetate, zirconium oxalate, zirconium lactate, zirconium phosphonate, zirconium octanoate, zirconium naphthenate, zirconium laurate, zirconium stearate, zirconium isostearate, zirconium butoxide methacrylate, stearate zirconium butoxide, and isostearate zirconium butoxide.

Examples of the titanium chelate compound include tetraisopropyl titanate, tetranormal butyl titanate, a butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compound include aluminum isopropylate, monobutoxyaluminum diisopropylate, aluminum butyrate, diethylacetoacetate aluminum diisopropylate, and aluminum tris(ethylacetoacetate).

These additives may be used alone or in a form of a mixture or a polycondensate of a plurality of compounds.

The undercoat layer may have, for example, a Vickers hardness of 35 or more.

For example, the surface roughness (ten-point average roughness) of the undercoat layer may be adjusted to ½ from 1/(4n) (n represents a refractive index of an upper layer) of a laser wavelength λ for exposure to be used to suppress moire fringes.

Resin particles or the like may be added to the undercoat layer to adjust the surface roughness. Examples of the resin particles include silicone resin particles and crosslinked polymethyl methacrylate resin particles. In addition, the surface of the undercoat layer may be polished to adjust the surface roughness. Examples of a polishing method include buff polishing, a sandblast treatment, wet honing, and a grinding treatment.

The formation of the undercoat layer is not particularly limited, and a known forming method is used. For example, a coating film of a coating solution for forming the undercoat layer, in which the above-described components are added to a solvent, is formed, and the coating film is dried and then heated as necessary.

Examples of the solvent for preparing the coating solution for forming the undercoat layer include known organic solvents such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of the solvent include typical organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method of dispersing the inorganic particles in a case of preparing the coating solution for forming the undercoat layer include known methods such as a roll mill, a ball mill, a vibration ball mill, an attritor, a sand mill, a colloid mill, and a paint shaker.

Examples of the method of coating the conductive substrate with the coating solution for forming the undercoat layer include typical coating methods such as a blade coating method, a wire bar coating method, a spray coating method, a dip coating method, a bead coating method, an air knife coating method, and a curtain coating method.

A layer thickness of the undercoat layer is set to, for example, preferably 15 μm or more and more preferably in a range of 20 μm or more and 50 μm or less.

### Interlayer

The interlayer is, for example, a layer containing a resin. Examples of the resin used for the interlayer include polymer compounds such as an acetal resin (for example, polyvinyl butyral or the like), a polyvinyl alcohol resin, a polyvinyl acetal resin, a casein resin, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenol-formaldehyde resin, and a melamine resin.

The interlayer may be a layer containing an organometallic compound. Examples of the organometallic compound used for the interlayer include organometallic compounds containing a metal atom such as zirconium, titanium, aluminum, manganese, and silicon.

The compounds used for the interlayer may be used alone or in a form of a mixture or a polycondensate of a plurality of compounds.

Among the above, for example, it is preferable that the interlayer is a layer containing an organometallic compound containing a zirconium atom or a silicon atom.

The formation of the interlayer is not particularly limited, and a known forming method is used. For example, a coating film of a coating solution for forming the interlayer, in which the above-described components are added to a solvent, is formed, and the coating film is dried and then heated as necessary.

Examples of the coating method of forming the interlayer include typical methods such as a dip coating method, a push-up coating method, a wire bar coating method, a spray coating method, a blade coating method, an air knife coating method, and a curtain coating method.

A layer thickness of the interlayer is set to, for example, preferably in a range of 0.1 μm or more and 3 μm or less. The interlayer may be used as the undercoat layer.

### Charge Generation Layer

A charge generation layer is, for example, a layer containing a charge generation material and a binder resin. In addition, the charge generation layer may be a deposition layer of the charge generation material. For example, the deposition layer of the charge generation material is suitable in a case where an incoherent light source such as a light emitting diode (LED) and an organic electro-luminescence (EL) image array is used.

Examples of the charge generation material include an azo pigment such as a bisazo pigment and a trisazo pigment; a fused ring aromatic pigment such as dibromoanthanthrone; a perylene pigment; a pyrrolopyrrole pigment; a phthalocyanine pigment; zinc oxide; and trigonal selenium.

Among the above, for example, a metal phthalocyanine pigment or a metal-free phthalocyanine pigment is preferably used as the charge generation material, in order to deal with laser exposure in a near-infrared region. Specifically, for example, hydroxy gallium phthalocyanine, chlorogallium phthalocyanine, dichlorotin phthalocyanine, or titanyl phthalocyanine is more preferable.

On the other hand, for example, a fused ring aromatic pigment such as dibromoanthanthrone, a thioindigo-based pigment, a porphyrazine compound, zinc oxide, trigonal selenium, or a bisazo pigment is preferable as the charge generation material in order to deal with laser exposure in a near-ultraviolet region.

The above-described charge generation material may be used even in a case where a non-coherent light source such as an LED having a central wavelength of light emission in a range of 450 nm or more and 780 nm or less and an organic EL image array is used.

In a case where a n-type semiconductor such as a fused ring aromatic pigment, a perylene pigment, and an azo pigment is used as the charge generation material, a dark current is unlikely to be generated, and image defects referred to as black spots can be suppressed even in a case in which a thin film is used as the photosensitive layer. The n-type is determined by the polarity of the flowing photocurrent using a typically used time-of-flight method, and a material in which electrons more easily flow as carriers than positive holes is determined as the n-type.

The binder resin used for the charge generation layer is selected from a wide range of insulating resins, and the binder resin may be selected from organic photoconductive polymers such as poly-N-vinylcarbazole, polyvinylanthracene, polyvinylpyrene, and polysilane.

Examples of the binder resin include a polyvinyl butyral resin, a polyarylate resin (polycondensate of bisphenols and aromatic divalent carboxylic acid, or the like), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin, and a polyvinylpyrrolidone resin. Here, the term “insulating” means that a volume resistivity is 1×10¹³ Ω·cm or more. The binder resins may be used alone or in a form of a mixture of two or more kinds thereof.

A blending ratio between the charge generation material and the binder resin is, for example, preferably in a range of 10:1 to 1:10 in terms of mass ratio.

The charge generation layer may also contain other known additives.

The formation of the charge generation layer is not particularly limited, and a known forming method is used. For example, a coating film of a coating solution for forming the charge generation layer, in which the above-described components are added to a solvent, is formed, and the coating film is dried and then heated as necessary. The charge generation layer may be formed by a vapor deposition of the charge generation material. For example, the formation of the charge generation layer by the vapor deposition is particularly preferable in a case where the fused ring aromatic pigment or the perylene pigment is used as the charge generation material.

Examples of the solvent for preparing the coating solution for forming the charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. The solvents are used alone or in a form of a mixture of two or more kinds thereof.

As a method of dispersing particles (for example, the charge generation material) in the coating solution for forming the charge generation layer, for example, a media disperser such as a ball mill, a vibration ball mill, an attritor, a sand mill, and a horizontal sand mill, or a medialess disperser such as a stirrer, an ultrasonic disperser, a roll mill, and a high-pressure homogenizer is used. Examples of the high-pressure homogenizer include a collision type high-pressure homogenizer in which a dispersion liquid is dispersed by a liquid-liquid collision or a liquid-wall collision in a high-pressure state, and a penetration type high-pressure homogenizer in which a dispersion liquid is dispersed by causing the dispersion liquid to penetrate through a micro-flow path in a high-pressure state. During the dispersion, it is effective to set an average particle diameter of the charge generation material in the coating solution for forming the charge generation layer to 0.5 μm or less, for example, preferably 0.3 μm or less and more preferably 0.15 μm or less.

Examples of the method of coating the undercoat layer (or the interlayer) with the coating solution for forming the charge generation layer include typical methods such as a blade coating method, a wire bar coating method, a spray coating method, a dip coating method, a bead coating method, an air knife coating method, and a curtain coating method.

A layer thickness of the charge generation layer is set to, for example, preferably in a range of 0.1 μm or more and 5.0 μm or less and more preferably in a range of 0.2 μm or more and 2.0 μm or less.

### Charge Transport Layer

A charge transport layer is, for example, a layer containing a binder resin and a charge transport material. The charge transport layer may be a layer containing a polymer charge transport material.

Examples of the charge transport material include a quinone-based compound such as p-benzoquinone, chloranil, bromanil, and anthraquinone; a tetracyanoquinodimethane-based compound; a fluorenone compound such as 2,4,7-trinitrofluorenone; a xanthone-based compound; a benzophenone-based compound; a cyanovinyl-based compound; and an electron-transporting compound such as an ethylene-based compound. Examples of the charge transport material also include a positive hole-transporting compound such as a triarylamine-based compound, a benzidine-based compound, an arylalkane-based compound, an aryl-substituted ethylene-based compound, a stilbene-based compound, an anthracene-based compound, and a hydrazone-based compound. The charge transport materials may be used alone or in combination of two or more kinds thereof, but are not limited thereto.

Examples of the polymer charge transport material include known chemical substances having charge transport properties, such as poly-N-vinylcarbazole and polysilane. For example, a polyester-based polymer charge transport material is preferable. The polymer charge transport material may be used alone or in combination of the binder resin.

Examples of the charge transport material or the polymer charge transport material include a polycyclic aromatic compound, an aromatic nitro compound, an aromatic amine compound, a heterocyclic compound, a hydrazone compound, a styryl compound, an enamine compound, a benzidine compound, a triarylamine compound (particularly, a triphenylamine compound), a diamine compound, an oxadiazole compound, a carbazole compound, an organic polysilane compound, a pyrazoline compound, an indole compound, an oxazole compound, an isoxazole compound, a thiazole compound, a thiadiazole compound, an imidazole compound, a pyrazole compound, a triazole compound, a cyano compound, a benzofuran compound, an aniline compound, a butadiene compound, and a resin having a group derived from any of these substances. Specific examples thereof include compounds described in paragraphs 0078 to 0080 of JP2021-117377A, paragraphs 0046 to 0048 of JP2019-035900A, paragraphs 0052 and 0053 of JP2019-012141A, paragraphs 0122 to 0134 of JP2021-071565A, paragraphs 0101 to 0110 of JP2021-015223A, paragraph 0116 of JP2013-097300A, paragraphs 0309 to 0316 of WO2019/070003A, paragraphs 0103 to 0107 of JP2018-159087A, and paragraphs 0102 to 0113 of JP2021-148818A.

From the viewpoint of charge mobility, for example, it is preferable that the charge transport material contains at least one selected from the group consisting of a chemical substance (C1) represented by Formula (C1), a chemical substance (C2) represented by Formula (C2), a chemical substance (C3) represented by Formula (C3), and a chemical substance (C4) represented by Formula (C4).

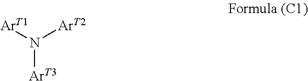

In Formula (C1), Ar^{T1}, Ar^{T2}, and Ar^{T3} are each independently an aryl group, —C₆H₄—C(R^{T4})═C(R^{T5})(R^{T6}), or —C₆H₄—CH═CH—CH═C(R^{T7})(R^{T8}). R^{T4}, R^{T5}, R^{T6}, R^{T7}, and R^{T8} are each independently a hydrogen atom, an alkyl group, or an aryl group. In a case where R^{T5} and R^{T6} are aryl groups, the aryl groups may be linked through a divalent group of —C(R⁵¹)(R⁵²)— and/or —C(R⁶¹)═C(R⁶²)—. R⁵¹, R⁵², R⁶¹, and R⁶² are each independently a hydrogen atom or an alkyl group having 1 or more and 3 or less carbon atoms.

The group in Formula (C1) may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

From the viewpoint of charge mobility, as the chemical substance (C1), for example, a chemical substance having at least one of an aryl group or —C₆H₄—CH═CH—CH═C(R^{T7})(R^{T8}) is preferable, and a chemical substance (C′1) represented by Formula (C′1) is more preferable.

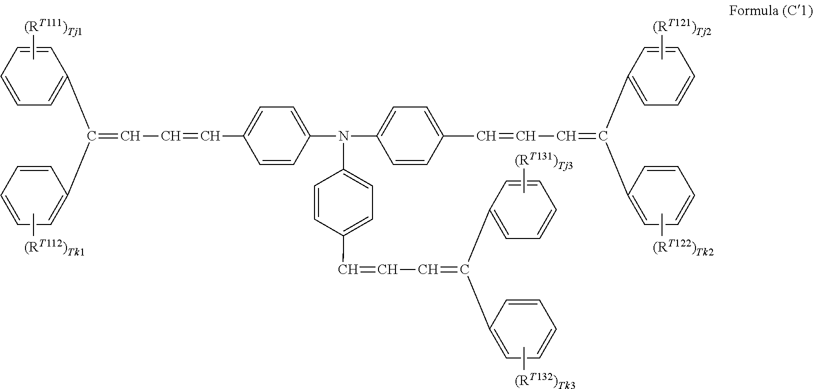

In Formula (C′1), R^{T111}, R^{T112}, R^{T121}, R^{T122}, R^{T131}, and R^{T132} are each independently a hydrogen atom, a halogen atom, an alkyl group (for example, preferably an alkyl group having 1 or more and 3 or less carbon atoms), an alkoxy group (for example, preferably an alkoxy group having 1 or more and 3 or less carbon atoms), a phenyl group, or a phenoxy group. Tj1, Tj2, Tj3, Tk1, Tk2, and Tk3 are each independently 0, 1, or 2.

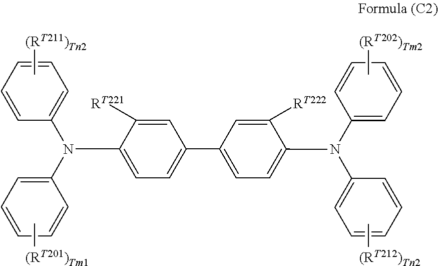

In Formula (C2), R^{T201}, R^{T202}, R^{T211}, and R^{T212} are each independently a halogen atom, an alkyl group having 1 or more and 5 or less carbon atoms, an alkoxy group having 1 or more and 5 or less carbon atoms, an amino group substituted with an alkyl group having 1 or 2 carbon atoms, an aryl group, —C(R^{T21})═C(R^{T22})(R^{T23}), or —CH═CH—CH═C(R^{T24})(R^{T25}). R^{T21}, R^{T22}, R^{T23}, R^{T24}, and R^{T25} are each independently a hydrogen atom, an alkyl group, or an aryl group. R^{T221} and R^{T222} are each independently a hydrogen atom, a halogen atom, an alkyl group having 1 or more and 5 or less carbon atoms, or an alkoxy group having 1 or more and 5 or less carbon atoms. Tm1, Tm2, Tn1, and Tn2 are each independently 0, 1, or 2.

The group in Formula (C2) may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

From the viewpoint of the charge mobility, as the chemical substance (C2), for example, a chemical substance having at least one of an alkyl group, an aryl group, or —CH═CH—CH═C(R^{T24})(R^{T25}) is preferable, and a chemical substance having two of an alkyl group, an aryl group, or —CH═CH—CH═C(R^{T24})(R^{T25}) is more preferable.

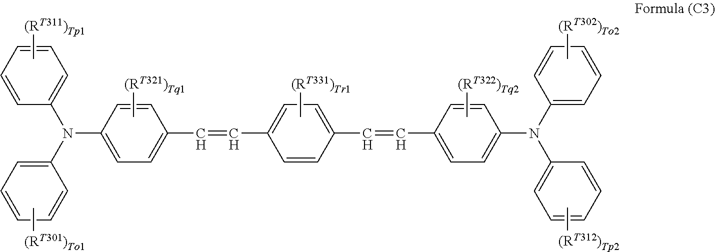

In Formula (C3), R^{T301}, R^{T302}, R^{T311}, and R^{T312} are each independently a halogen atom, an alkyl group having 1 or more and 5 or less carbon atoms, an alkoxy group having 1 or more and 5 or less carbon atoms, an amino group substituted with an alkyl group having 1 or 2 carbon atoms, an aryl group, —C(R^{T31})═C(R^{T32})(R^{T33}), or —CH═CH—CH═C(R^{T34})(R^{T35}). R^{T31}, R^{T32}, R^{T33}, R^{T34}, and R^{T35} are each independently a hydrogen atom, an alkyl group, or an aryl group. R^{T321}, R^{T322}, and R^{T331} are each independently a hydrogen atom, a halogen atom, an alkyl group having 1 or more and 5 or less carbon atoms, or an alkoxy group having 1 or more and 5 or less carbon atoms. To1, To2, Tp1, Tp2, Tq1, Tq2, and Tr1 are each independently 0, 1, or 2.

The group in Formula (C3) may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

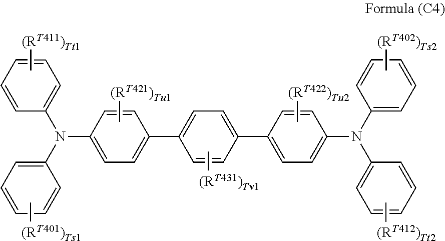

In Formula (C4), R^{T401}, R^{T402}, R^{T411}, and R^{T412} are each independently a halogen atom, an alkyl group having 1 or more and 5 or less carbon atoms, an alkoxy group having 1 or more and 5 or less carbon atoms, an amino group substituted with an alkyl group having 1 or 2 carbon atoms, an aryl group, —C(R^{T41})═C(R^{T42})(R^{T43}), or —CH═CH—CH═C(R^{T44})(R^{T45}). R^{T41}, R^{T42}, R^{T43}, R^{T44}, and R^{T45} are each independently a hydrogen atom, an alkyl group, or an aryl group. R^{T421}, R^{T422}, and R^{T431} are each independently a hydrogen atom, a halogen atom, an alkyl group having 1 or more and 5 or less carbon atoms, or an alkoxy group having 1 or more and 5 or less carbon atoms. Ts1, Ts2, Tt1, Tt2, Tu1, Tu2, and Tv1 are each independently 0, 1, or 2.

The group in Formula (C4) may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

The charge transport layer contains at least a polyarylate resin as a binder resin, and may contain other binder resins other than the polyarylate resin. Examples of other binder resins include a polycarbonate resin, an aliphatic polyester resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-vinylcarbazole, and polysilane.

A blending ratio between the charge transport material and the binder resin is, for example, preferably 10:1 to 1:5 in terms of mass ratio.

In a case where the charge transport layer is the outermost surface layer of the photoreceptor, the charge transport layer may contain a phenolic compound having 3 or less phenolic functional groups and having a molecular weight of 300 or more. A form of the phenolic compound is as follows.

From the viewpoint of suppressing molecular polarity, in the phenolic compound having 3 or less phenolic functional groups and a molecular weight of 300 or more, for example, it is preferable that the number of phenolic functional groups is small and the molecular weight is large.

The number of phenolic functional groups in the phenolic compound is 3 or less, and for example, preferably 1 or 2. The molecular weight of the phenolic compound is 300 or more, and for example, preferably 350 or more, more preferably 400 or more, and still more preferably 450 or more. From the viewpoint of easy dispersion in the outermost surface layer, the upper limit of the molecular weight of the phenolic compound is, for example, preferably 1,000 or less, more preferably 900 or less, and still more preferably 800 or less.

The phenolic compound is, for example, preferably a phenolic compound having 2 or less phenolic functional groups and having a molecular weight of 350 or more, more preferably a phenolic compound having 2 or less phenolic functional groups and having a molecular weight of 350 or more and 1,000 or less, still more preferably a phenolic compound having 2 or less phenolic functional groups and having a molecular weight of 400 or more and 900 or less, and even more preferably a phenolic compound having 2 or less phenolic functional groups and having a molecular weight of 450 or more and 800 or less.

In the present disclosure, the phenolic functional group of the phenolic compound means a hydroxy group bonded to a benzene ring.

Examples of the phenolic compound having 3 or less phenolic functional groups and a molecular weight of 300 or more include a hindered phenolic compound. The hindered phenolic compound is generally a compound in which at least one of ortho-positions of a hydroxy group of phenol is substituted with a bulky group, the compound exhibiting an oxidation inhibiting action of a composition. The hindered phenolic compound may be used alone or in combination of two or more kinds thereof.

Examples of the hindered phenolic compound include the following.
Alkylated monophenol compounds and derivatives thereof: for example, octyl-3,5-di-t-butyl-4-hydroxy-hydrocinnamate
Alkyl thiomethyl phenol compounds and derivatives thereof: for example, 2,4-dioctylthiomethyl-6-t-butylphenol, 2,4-dioctylthiomethyl-6-methylphenol, 2,4-dioctylthiomethyl-6-ethylphenol, and 2,6-didodecylthiomethyl-4-nonylphenol
Alkylidene bisphenol compounds and derivatives thereof: for example, 4,4′-butylidenebis(6-t-butyl-3-methylphenol), 2,2′-methylenebis(6-t-butyl-4-methylphenol), 2,2′-methylenebis(6-t-butyl-4-ethylphenol), 2-t-butyl-6-(3-t-butyl-2-hydroxy-5-methylbenzyl)-4-methylphenyl acrylate, and 3,9-bis[2-[3-(3-t-butyl-4-hydroxy-5-methylphenyl) propionyloxy]-1,1-dimethylethyl]-2,4,8,10-tetraoxaspiro[5.5]undecane

Examples of a commercially available product of the hindered phenolic compound include “ADEKA STAB AO-80”, “ADEKA STAB AO-50”, “ADEKA STAB AO-40”, “ADEKA STAB AO-30”, “ADEKA STAB AO-20”, and “ADEKA STAB AO-330” of ADEKA Corporation; “Irganox 245”, “Irganox 1076”, and “Irganox 1520” of BASF Japan Ltd.; and “Sumilizer GA-80”, “Sumilizer GM”, and “Sumilizer GS” of Sumitomo Chemical Co., Ltd.

A content of the phenolic compound contained in the outermost surface layer is, for example, preferably 0.1% by mass or more and 20% by mass or less, more preferably 0.5% by mass or more and 10% by mass or less, and still more preferably 1% by mass or more and 5% by mass or less with respect to the total mass of the outermost surface layer.

The charge transport layer may also contain other known additives.

The formation of the charge transport layer is not particularly limited, and a known formation method is used. For example, the charge transport layer is obtained by forming a coating film of a coating solution for forming the charge transport layer, that is obtained by adding the above-described components to a solvent, drying the coating film, and heating the coating film as necessary.

Examples of the solvent for preparing the coating solution for forming the charge transport layer include typical organic solvents, for example, aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. The solvents are used alone or in a form of a mixture of two or more kinds thereof.

Examples of the coating method of coating the charge generation layer with the coating solution for forming the charge transport layer include typical methods such as a blade coating method, a wire bar coating method, a spray coating method, a dip coating method, a bead coating method, an air knife coating method, and a curtain coating method.

A layer thickness of the charge transport layer is, for example, preferably set in a range of 5 μm or more and 50 μm or less, more preferably set in a range of 8 μm or more and 45 μm or less, and still more preferably set in a range of 10 μm or more and 40 μm or less.

### Charging Member

The charging member may be any of a charging member in a system in which only a direct current voltage is applied (DC charging system), a charging member in a system in which only an alternating current voltage is applied (AC charging system), or a charging member in a system in which a voltage obtained by superimposing an alternating voltage on a direct voltage is applied (AC/DC charging system).

The charging member comes into contact with the surface of the photoreceptor to charge the photoreceptor. The charging member includes a support member, an elastic layer disposed on the support member, and a surface layer disposed on the elastic layer. The charging member may have a roll shape or a belt shape.

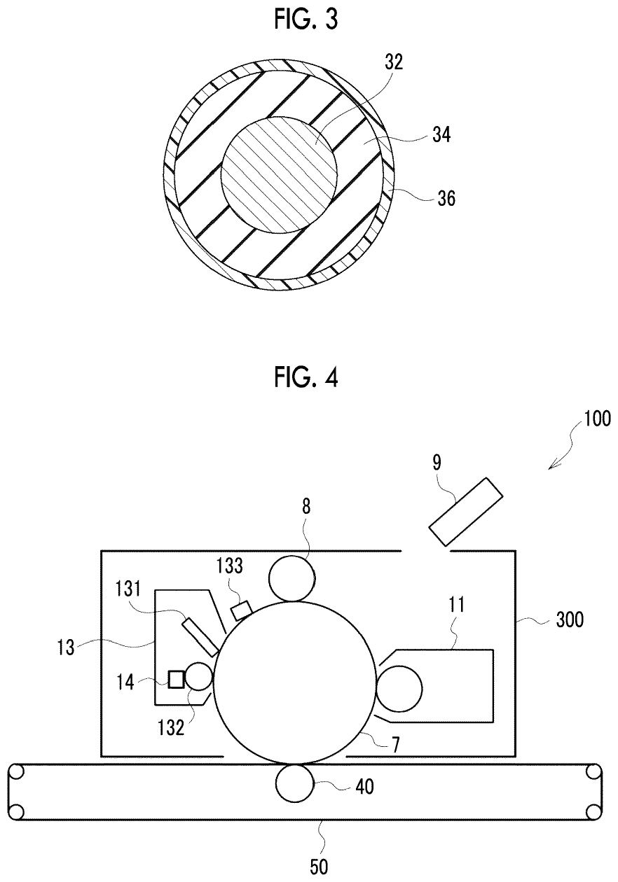

FIG. 2 is a schematic perspective view showing an example of the charging member. FIG. 3 is a cross-sectional view taken along a line A-A of FIG. 2, and is a cross-sectional view of the charging member shown in FIG. 2 taken in a radial direction.

A charging member 30 shown in FIG. 2 is a roll-shaped charging member. The charging member 30 has a structure in which an elastic layer 34 and a surface layer 36 are laminated in this order on a support member 32. The charging member 30 may have an adhesive layer (not shown) between the support member 32 and the elastic layer 34 and/or between the elastic layer 34 and the surface layer 36. The surface layer 36 is the outermost layer of the charging member 30.

From the viewpoint of preventing occurrence of the fogging in the image in a low-temperature and low-humidity environment, a ten-point average roughness RzJIS (JIS B 0601:2013) of an outer peripheral surface (that is, the surface of the surface layer) of the charging member is, for example, preferably 5.9 μm or less, more preferably 5.7 μm or less, and still more preferably 5.5 μm or less.

From the viewpoint of easily achieving the ten-point average roughness RzJIS of the outer peripheral surface of the charging member, the ten-point average roughness RzJIS is, for example, preferably 5.0 μm or more.

The ten-point average roughness RzJIS of the outer peripheral surface of the charging member is measured according to provisions of JIS B 0601:2013.

A measurement environment is a temperature of 22° C. and a relative humidity of 55%. A sample is placed in the measurement environment for 24 hours or more, and the temperature and humidity are controlled. A contact-type surface roughness measuring instrument (Surfcom, Tokyo Seimitsu Co., Ltd.) is used, a measuring element is a conical shape with an apex angle of 90°, a curvature radius of a tip is 5 μm, and a tip material is diamond. The measurement is performed by scanning, in the axial direction, a central portion of the charging member in the axial direction at a scanning speed of 0.30 mm/see, a measurement length of 4.0 mm, and a cutoff value of 0.8 mm.

The surface roughness of the outer peripheral surface of the charging member can be controlled by a particle diameter and a content of particle-like components contained in the surface layer.

### Support Member

The support member is a conductive member that functions as an electrode and a support of the charging member. The support member may be a hollow member or a non-hollow member, and may be, for example, a rod-like, cylindrical, or endless belt-like member.

Examples of the support member include a member made of a metal such as iron (free-cutting steel or the like), copper, copper alloy, brass, stainless steel, aluminum, and nickel; an iron member plated with chromium, nickel, or the like; a member obtained by performing a plating treatment on an outer peripheral surface of a resin or ceramic member; and a resin or ceramic member containing a conductive agent.

### Elastic Layer

The elastic layer has conductivity, and a volume resistivity at a temperature of 20° C. is, for example, preferably 1×10³ Ω·cm or more and 1×10¹⁴ Ω·cm or less.

The volume resistivity of the elastic layer is a value measured by the following method. After removing the surface layer of the charging member by polishing, the elastic layer is cut out from the central portion of the charging member in the axial direction to have an axial length of 25 mm and a circumferential length of 8 mm, and is used as a sample. A thickness of the sample (that is, the elastic layer) is measured. A voltage is applied to the sample for 30 seconds using a measuring jig (R12702A/B resistivity chamber; manufactured by ADVANTEST CORPORATION) and a high resistance measuring instrument (R8340A digital high resistance/microcurrent meter; manufactured by ADVANTEST CORPORATION) so that an electric field (applied voltage/composition sheet thickness) is 1,000 V/cm, according to JIS K 6911:1995. The current value is read and calculated according to the following expression.

Volume resistivity (Ω·cm)=(Sample area (cm²)×Applied voltage(V))/(Current value(A)×Thickness of sample (cm))

The elastic layer may be a foamed elastic layer or a non-foamed elastic layer. The elastic layer may be disposed on the outer peripheral surface of the support member directly or through an adhesive layer.

Examples of an exemplary embodiment of the elastic layer include an elastic layer that contains an elastic material, a conductive agent, and other additives.

Examples of the elastic material include polyurethane rubber, nitrile rubber, isoprene rubber, butadiene rubber, ethylene-propylene rubber, ethylene-propylene-diene rubber, epichlorohydrin rubber, epichlorohydrin-ethylene oxide rubber, epichlorohydrin-ethylene oxide-allyl glycidyl ether rubber, styrene-butadiene rubber, acrylonitrile-butadiene rubber, chloroprene rubber, chlorinated polyisoprene rubber, hydrogenated polybutadiene rubber, butyl rubber, silicone rubber, fluororubber, natural rubber, and elastic materials obtained by mixing two or more of these materials. Among these elastic materials, for example, polyurethane rubber, silicone rubber, ethylene-propylene-diene rubber, epichlorohydrin-ethylene oxide rubber, epichlorohydrin-ethylene oxide-allyl glycidyl ether rubber, acrylonitrile-butadiene rubber, or an elastic material obtained by mixing two or more of these is preferable.

Examples of the conductive agent include an electron conductive agent and an ion conductive agent. Examples of the electron conductive agent include powder, for example, carbon black such as furnace black, thermal black, channel black, ketjen black, acetylene black, and color black; thermally decomposed carbon; graphite; a metal such as aluminum, copper, nickel, and stainless steel, and an alloy thereof; a metal oxide such as tin oxide, indium oxide, titanium oxide, a tin oxide-antimony oxide solid solution, and a tin oxide-indium oxide solid solution; and a substance obtained by performing a conduction treatment on the surface of an insulating material. Examples of the ion conductive agent include perchlorates or chlorates of tetraethylammonium, lauryltrimethylammonium, and benzyltrialkylammonium; and perchlorates or chlorates of alkali metals such as lithium and magnesium and alkaline earth metals. The conductive agent may be used alone or in combination of two or more kinds thereof.

For example, it is preferable that the total content of the conductive agent contained in the elastic layer is set using the volume resistivity of the elastic layer as a reference.

In a case where the electron conductive agent is used as the conductive agent, the total amount of the electron conductive agent may be, for example, 1 part by mass or more and 20 parts by mass or less, or 3 parts by mass or more and 20 parts by mass or less with respect to 100 parts by mass of the elastic material.

In a case where the ion conductive agent is used as the conductive agent, the total amount of the ion conductive agent may be, for example, 0.1 parts by mass or more and 10 parts by mass or less, or 0.5 parts by mass or more and 5 parts by mass or less with respect to 100 parts by mass of the elastic material.

An average primary particle size of the conductive agent is, for example, preferably 1 nm or more and 500 nm or less, and more preferably 5 nm or more and 200 nm or less. The average primary particle size of the conductive agent is obtained by observing a cross section of the elastic layer with an electron microscope, measuring major axes of 100 conductive agent particles, and arithmetically averaging the measured values.

As the conductive agent, for example, carbon black is preferable. An average primary particle size of the carbon black is, for example, preferably 1 nm or more and 500 nm or less, and more preferably 5 nm or more and 200 nm or less.

A content of the carbon black is, for example, preferably 1 part by mass or more and 20 parts by mass or less, and more preferably 3 parts by mass or more and 10 parts by mass or less with respect to 100 parts by mass of the elastic material.

Examples of other additives include a vulcanization agent, a vulcanization accelerator, a vulcanization accelerator assistant, a filler, a softener, a plasticizer, a curing agent, an antioxidant, a surfactant, and a coupling agent.

Examples of the filler include calcium carbonate, silica, and clay mineral. The filler may be used alone or in combination of two or more kinds thereof.

As the filler, for example, calcium carbonate is preferable. A content of the calcium carbonate is, for example, preferably 1 part by mass or more and 50 parts by mass or less, and more preferably 10 parts by mass or more and 40 parts by mass or less with respect to 100 parts by mass of the elastic material.

A layer thickness of the elastic layer is, for example, preferably 5 mm or more and 20 mm or less, and more preferably 10 mm or more and 15 mm or less.

The layer thickness of the elastic layer is measured by imaging a cross section with an electron microscope. A value obtained by measuring four positions at intervals of 90° in the circumferential direction at the center of the charging member in the axial direction and calculating the arithmetic mean thereof is defined as the layer thickness of the elastic layer.

Examples of a method of forming the elastic layer on the support member include a method of extruding a composition for forming the elastic layer, that is obtained by mixing the elastic material, the conductive agent, and other additives, together with a cylindrical support member from an extrusion molding machine, forming a layer of the composition for forming the elastic layer on an outer peripheral surface of the support member, and heating the layer of the composition for forming the elastic layer by a crosslinking reaction (including vulcanization) so that the elastic layer is obtained; and a method of extruding a composition for forming the elastic layer, that is obtained by mixing the elastic material, the conductive agent, and other additives, onto the outer peripheral surface of an endless belt-like support member from an extrusion molding machine, forming a layer of the composition for forming the elastic layer on the outer peripheral surface of the support member, and heating the layer of the composition for forming the elastic layer by a crosslinking reaction (including vulcanization) so that the elastic layer is obtained. The support member may include an adhesive layer on the outer peripheral surface thereof.

### Adhesive Layer

An adhesive layer for adhering the support member and the elastic layer to each other may be provided between the support member and the elastic layer.

Specific examples of the adhesive layer sandwiched between the support member and the elastic layer include a layer containing a resin such as polyolefin, an acrylic resin, an epoxy resin, polyurethane, nitrile rubber, chlorine rubber, a vinyl chloride resin, a vinyl acetate resin, a polyester resin, a phenol resin, and a silicone resin. The adhesive layer may contain a conductive agent (for example, the electron conductive agent or the ion conductive agent described above).

From the viewpoint of adhesiveness between the elastic layer and the support member, a layer thickness of the adhesive layer is, for example, preferably 1 μm or more and 50 μm or less, more preferably 2 μm or more and 40 μm or less, and still more preferably 5 μm or more and 20 μm or less.

The layer thickness of the adhesive layer is measured by imaging a cross section with an electron microscope. A value obtained by measuring four positions at intervals of 90° in the circumferential direction at the center of the charging member in the axial direction and calculating the arithmetic mean thereof is defined as the layer thickness of the adhesive layer.

### Surface Layer

The surface layer has conductivity, and a volume resistivity at a temperature of 20° C. is, for example, preferably 1×10³ Ω·cm or more and 1×10¹⁴ Ω·cm or less. The volume resistivity of the surface layer is a value measured by the following method.

A layer thickness of the surface layer is measured by a measuring method described later. A support member of the charging member is used as a cathode, and an aluminum plate having a width of 1.5 cm, that is wound once around the surface layer, is used as an anode. SI 1260 impedance/gain phase analyzer (TOYO Corporation) is used as a power supply and a current meter, and 1296 dielectric interface (TOYO Corporation) is used as a current amplifier. An alternating current voltage of 1 Vp-p is applied from the high frequency side at a frequency of from 1 kHz to 0.01 Hz. A resistance component of the impedance in a range of 100 Hz to 0.1 Hz is obtained as a value of a volume resistance of the surface layer. The volume resistivity of the surface layer is calculated by the following expression.

Volume resistivity (Ω·cm)=Volume resistance (Ω)×Area of anode (cm²)/Layer thickness of surface layer (cm)

The surface layer contains a resin, conductive particles, and a silicon compound.

Examples of the resin include copolymerized nylon, polyamide, polyimide, polyamideimide, polyvinyl butyral, polyester, polyethylene terephthalate, polyarylate, polycarbonate, polyethylene, polyurethane, a phenol resin, a silicone resin, an acrylic resin, a fluorine-modified acrylic resin, a silicone-modified acrylic resin, a melamine resin, an epoxy resin, a fluororesin, a polyvinylidene fluoride resin, a tetrafluoroethylene resin, an ethylene-tetrafluoroethylene copolymer, a tetrafluoroethylene-perfluoroalkyl vinyl ether copolymer, a tetrafluoroethylene-hexafluoropropylene copolymer, a fluorine rubber, a polyvinyl resin, polyvinyl alcohol, polyvinyl acetal, polyvinylidene chloride, polyvinyl chloride, an ethylene-vinyl acetate copolymer, cellulose, a polythiophene resin, a resin obtained by mixing two or more of these resins, and a resin obtained by curing or crosslinking at least one of these resins with a curing agent or a catalyst. The resin may be used alone or in combination of two or more kinds thereof.

From the viewpoint of suppressing contamination of the surface layer, the resin contained in the surface layer is, for example, preferably a polyamide resin, a polyvinylidene fluoride resin, or a tetrafluoroethylene resin, and more preferably a polyamide resin. From the viewpoint of suppressing the contamination of the surface layer, as the polyamide resin, for example, alcohol-soluble polyamide is preferable, alkoxymethylated polyamide (for example, alkoxymethylated nylon) is more preferable, and methoxymethylated polyamide (for example, methoxymethylated nylon) is still more preferable.

From the viewpoint of binding properties with the conductive particles, for example, the surface layer preferably contains a polyvinyl butyral resin. From the viewpoint of suppressing the contamination of the surface layer and forming excellent image quality, and the viewpoint of the binding properties with the conductive particles, for example, the surface layer preferably contains a polyamide resin and a polyvinyl butyral resin as a binder resin. In the present embodiment, a proportion of the polyvinyl butyral resin in the total amount of the polyamide resin and the polyvinyl butyral resin is, for example, preferably 10% by mass or more and 30% by mass or less, more preferably 12% by mass or more and 25% by mass or less, and still more preferably 15% by mass or more and 20% by mass or less.

Examples of the conductive particles include carbon black, and a metal oxide such as tin oxide, titanium oxide, and zinc oxide. As the conductive particles contained in the surface layer, for example, carbon black is preferable. The conductive particles may be used alone or in combination of two or more kinds thereof.

From the viewpoint of excellent dispersibility in the resin, for example, it is preferable that the conductive particles contained in the surface layer have an average primary particle size of 10 nm or more and 50 nm or less.

The average primary particle size of the conductive particles is obtained by observing a cross section of the surface layer with an electron microscope, measuring major axes of 100 conductive particles, and arithmetically averaging the measured values.

A content of the conductive particles contained in the surface layer is, for example, preferably 5 parts by mass or more and 30 parts by mass or less, more preferably 8 parts by mass or more and 25 parts by mass or less, and still more preferably 10 parts by mass or more and 20 parts by mass or less with respect to 100 parts by mass of the binder resin.

Examples of the silicon compound include at least one silicone oil selected from the group consisting of dimethylpolysiloxane and an organic group-substituted derivative of dimethylpolysiloxane. Examples of the organic group-substituted derivative of dimethylpolysiloxane include polyether-modified silicone oil and methylstyryl-modified silicone oil.

From the viewpoint of image quality, a content of the silicon compound contained in the surface layer is, for example, preferably 0.01 parts by mass or more and 1 part by mass or less, more preferably 0.02 parts by mass or more and 0.5 parts by mass or less, and still more preferably 0.03 parts by mass or more and 0.1 parts by mass or less with respect to 100 parts by mass of the binder resin.

From the viewpoint of image quality, a content of the silicone oil contained in the surface layer is, for example, preferably 0.01 parts by mass or more and 1 part by mass or less, more preferably 0.02 parts by mass or more and 0.5 parts by mass or less, and still more preferably 0.03 parts by mass or more and 0.1 parts by mass or less with respect to 100 parts by mass of the binder resin.

The surface layer may contain organic resin particles for the purpose of adjusting a surface roughness.

The surface layer may contain various additives. Examples of the additive include a filler, a softening agent, a plasticizer, a curing agent, an antioxidant, a coupling agent, a surfactant, an antifoaming agent, and a leveling agent.

A layer thickness of the surface layer is, for example, preferably 1 μm or more and 25 μm or less, more preferably 3 μm or more and 20 μm or less, and still more preferably 5 μm or more and 15 μm or less.

The layer thickness of the surface layer is measured by imaging a cross section with an electron microscope. A value obtained by measuring four positions at intervals of 90° in the circumferential direction at the center of the charging member in the axial direction and calculating the arithmetic mean thereof is defined as the layer thickness of the surface layer.

Examples of a method of forming the surface layer on the elastic layer include a method of applying a composition for forming the surface layer, that is obtained by mixing the resin, the conductive particles, the silicon compound, and other additives, onto the outer peripheral surface of the elastic layer to form a layer of the composition for forming the surface layer, and then drying the layer of the composition for forming the surface layer. Examples of a method of coating the outer peripheral surface of the elastic layer with the composition for forming the surface layer include dip coating, roll coating, blade coating, wire bar coating, spray coating, bead coating, air knife coating, and curtain coating.

### Image Forming Apparatus and Process Cartridge

The image forming apparatus according to the present disclosure includes a photoreceptor, a charging member that charges a surface of the photoreceptor, an electrostatic latent image forming unit that forms an electrostatic latent image on the charged surface of the photoreceptor, a developing unit that develops the electrostatic latent image formed on the surface of the photoreceptor with a developer containing a toner to form a toner image, and a transferring unit that transfers the toner image to a surface of a recording medium. The image forming unit according to the present disclosure is applied as the photoreceptor and the charging member.

As the image forming apparatus according to the present disclosure, a known image forming apparatus such as an apparatus including a fixing device that fixes the toner image transferred to the surface of a recording medium; a direct transfer-type apparatus that transfers the toner image formed on the surface of the photoreceptor directly to the recording medium; an intermediate transfer-type apparatus that primarily transfers the toner image formed on the surface of the photoreceptor to a surface of an intermediate transfer member and secondarily transfers the toner image transferred to the surface of the intermediate transfer member to the surface of the recording medium; an apparatus including a cleaning device that cleans the surface of the photoreceptor after the transfer of the toner image and before the charging; an apparatus including a discharging device that discharges the surface of the photoreceptor by applying the discharge light after the transfer of the toner image and before the charging; or an apparatus including an photoreceptor heating member for increasing the temperature of the photoreceptor and decreasing the relative temperature is adopted.

In a case of the intermediate transfer-type apparatus, the transfer device has a configuration including an intermediate transfer member with surface on which the toner image will be transferred, a primary transfer device that performs primary transfer to transfer the toner image formed on the surface of the photoreceptor to the surface of the intermediate transfer member, and a secondary transfer device that performs secondary transfer to transfer the toner image transferred to the surface of the intermediate transfer member to the surface of a recording medium.

The image forming apparatus according to the present disclosure may be any of a dry development-type image forming apparatus or a wet development-type (development type using a liquid developer) image forming apparatus.

In the image forming apparatus according to the present disclosure, for example, a portion including the photoreceptor may have a cartridge structure (process cartridge) that is attachable to and detachable from the image forming apparatus. As the process cartridge, for example, a process cartridge including the image forming unit according to the present disclosure is suitably used. The process cartridge may include, for example, at least one selected from the group consisting of an electrostatic latent image forming unit, a developing unit, and a transferring unit, in addition to the photoreceptor and the charging member.

An example of the image forming apparatus according to the present disclosure will be shown below, but the present disclosure is not limited thereto. Among the parts shown in the drawing, main parts will be described, and others will not be described.

FIG. 4 is a schematic configuration view showing an example of the image forming apparatus according to the present disclosure.

As shown in FIG. 4, an image forming apparatus 100 includes a process cartridge 300, an exposure device 9 (an example of the electrostatic latent image forming device), a transfer device 40 (primary transfer device), and an intermediate transfer member 50. In the image forming apparatus 100, the exposure device 9 is disposed at a position that can be exposed to the photoreceptor 7 from an opening portion of the process cartridge 300; the transfer device 40 is disposed at a position that faces the photoreceptor 7 through the intermediate transfer member 50; and the intermediate transfer member 50 is disposed such that a part of the intermediate transfer member 50 is in contact with the photoreceptor 7. Although not shown, the image forming apparatus also includes a secondary transfer device that transfers the toner image transferred to the intermediate transfer member 50 to a recording medium (for example, paper). The intermediate transfer member 50, the transfer device 40 (primary transfer device), and the secondary transfer device (not shown) correspond to an example of the transfer device.

In the process cartridge 300, the photoreceptor 7, the charging device 8, the developing device 11, and the cleaning device 13 are integrally supported in a housing. The cleaning device 13 has a cleaning blade (an example of a cleaning member) 131, and the cleaning blade 131 is disposed to come into contact with the surface of the photoreceptor 7. The cleaning member may be a conductive or insulating fibrous member instead of the aspect of the cleaning blade 131, and may be used alone or in combination with the cleaning blade 131. The image forming unit according to the present disclosure is applied as the photoreceptor 7 and the charging member of the charging device 8.

FIG. 4 shows an example of an image forming apparatus including a fibrous member 132 (roll shape) that supplies a lubricant 14 to the surface of the photoreceptor 7 and a fibrous member 133 (flat brush shape) that assists the cleaning, but these are disposed as necessary.

Each configuration other than the photoreceptor 7 and the charging device 8 will be described below.

### Exposure Device

Examples of the exposure device 9 include an optical system device that exposes the surface of the photoreceptor 7 to light such as a semiconductor laser beam, LED light, and liquid crystal shutter light in a predetermined image pattern. A wavelength of the light source is set to be within a spectral sensitivity region of the photoreceptor. As a wavelength of a semiconductor laser, near infrared laser, which has an oscillation wavelength in the vicinity of 780 nm, is mostly used. However, the wavelength is not limited thereto, and a laser having an oscillation wavelength of an approximately 600 nm level or a laser having an oscillation wavelength of 400 nm or more and 450 nm or less as a blue laser may also be used. In addition, a surface emission-type laser light source capable of outputting a multi-beam is also effective for forming a color image.

### Developing Device

Examples of the developing device 11 include a typical developing device that performs development in contact or non-contact with the developer. The developing device 11 is not particularly limited as long as the device has the above-described functions, and is selected depending on the purpose thereof. Examples thereof include known developing machines having a function of attaching a one-component developer or a two-component developer to the photoreceptor 7 using a brush, a roller, or the like. Among the above, for example, a developing roller in which a developer is retained on a surface is preferably used.

The developer used in the developing device 11 may be a one-component developer containing only a toner or a two-component developer containing a toner and a carrier. In addition, the developer may be magnetic or non-magnetic. These developers are adopted as the developer.

### Cleaning Device

As the cleaning device 13, a cleaning blade-type device including the cleaning blade 131 is used. In addition to the cleaning blade-type device, a fur brush cleaning-type device or a simultaneous development cleaning-type device may be adopted.

### Transfer Device

Examples of the transfer device 40 include a known transfer charger such as a contact type transfer charger using a belt, a roller, a film, a rubber blade, or the like, and a scorotron transfer charger or a corotron transfer charger using corona discharge.

### Intermediate Transfer Member

As the intermediate transfer member 50, a semi-conductive belt-like intermediate transfer member (intermediate transfer belt) containing polyimide, polyamide-imide, polycarbonate, polyarylate, polyester, rubber, or the like is used. In addition, as the form of the intermediate transfer member, a drum-like intermediate transfer member may be used in addition to the belt-like intermediate transfer member.

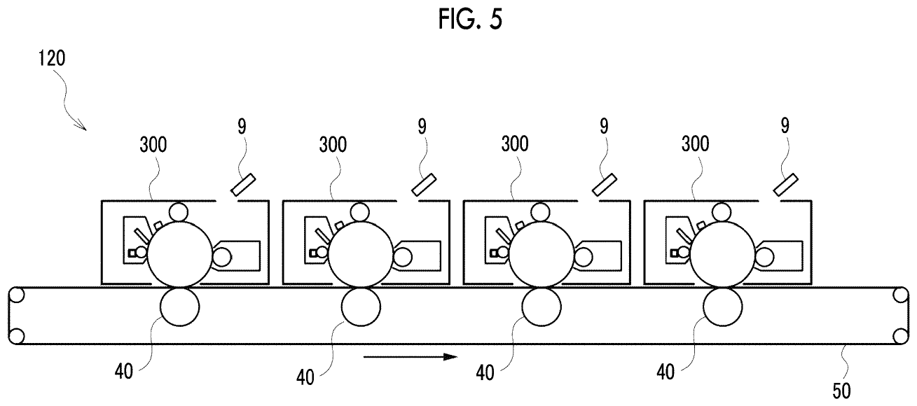

FIG. 5 is a schematic configuration view showing another example of the image forming apparatus according to the present disclosure.

An image forming apparatus 120 shown in FIG. 5 is a tandem type multicolor image forming apparatus in which four process cartridges 300 are mounted. The image forming apparatus 120 is formed such that the four process cartridges 300 are arranged in parallel on the intermediate transfer member 50, and one photoreceptor is used for each color. The image forming apparatus 120 has the same configuration as the image forming apparatus 100, except that the image forming apparatus 120 is of a tandem type.

### EXAMPLES

Hereinafter, exemplary embodiments of the present invention will be specifically described based on Examples. However, the exemplary embodiments of the present invention are not limited to Examples.

In the following description, unless otherwise specified, “parts” and “%” are based on mass.

In the following description, the synthesis, the treatment, the production, and the like are carried out at room temperature (25° C.±3° C.) unless otherwise specified.

### Production of Photoreceptor

### Photoreceptor (1)

### Formation of Undercoat Layer

100 parts of zinc oxide particles (average particle size: 70 nm, specific surface area: 15 m²/g, Tayca Corporation) is stirred and mixed with 500 parts of tetrahydrofuran, 1.25 parts of a silane coupling agent (N-2-(aminoethyl)-3-aminopropyltrimethoxysilane, trade name: KBM603, manufactured by Shin-Etsu Chemical Co., Ltd.) is added thereto, and the mixture is stirred for 2 hours. The tetrahydrofuran is distilled off under reduced pressure and baked at 120° C. for 3 hours to obtain zinc oxide particles subjected to a surface treatment with the silane coupling agent.

60 parts of the surface-treated zinc oxide particles, 0.6 parts of 4-ethoxy-1,2-dihydroxy-9,10-anthraquinone, 13.5 parts of a curing agent (blocked isocyanate, trade name: SUMIDUR 3173, Sumitomo Bayer Urethane Co., Ltd.), 5 parts of a butyral resin (trade name: S-LEC BM-1, Sekisui Chemical Co., Ltd.), and 42 parts of methyl ethyl ketone are mixed with each other, and the mixture is dispersed in a sand mill for 4 hours using glass beads with a diameter of 1 mm, thereby obtaining a dispersion. 0.005 parts of dioctyl tin dilaurate as a catalyst and 4 parts of silicone resin particles (trade name: TOSPEARL 145, Momentive Performance Materials Inc.) are added to the dispersion liquid to obtain a coating solution for forming an undercoat layer.

An outer peripheral surface of an aluminum cylindrical tube (conductive substrate) with an outer diameter of 30 mm and a thickness of 1 mm is coated with the coating solution for forming an undercoat layer by a dip coating method, and dried and cured at 180° C. for 40 minutes, thereby forming an undercoat layer having an average thickness of 25 μm.

### Formation of Charge Generation Layer

15 parts of a charge generating substance chlorogallium phthalocyanine (having diffraction peaks at positions of a Bragg angle (20+) 0.2° of at least 7.4°, 16.6°, 25.5°, and 28.3° in an X-ray diffraction spectrum using CuKα characteristic X-rays), 10 parts of a vinyl chloride-vinyl acetate copolymer as a binder resin, and 300 parts of n-butyl alcohol are mixed and dispersed for 4 hours using a sand mill with glass beads having a diameter of 1 mm, thereby obtaining a coating solution for forming a charge generation layer.

The undercoat layer is dipped in and coated with the coating solution for forming a charge generation layer, and dried at 120° C. for 5 minutes, thereby forming a charge generation layer having an average thickness of 0.2 μm.

### Formation of Charge Transport Layer

40 parts of a charge transport material N,N′-bis(3-methylphenyl)-N,N′-diphenylbenzidine and 60 parts of a polyarylate resin (PA1) as a binder resin are dissolved in 270 parts of tetrahydrofuran and 30 parts of toluene to obtain a coating solution for forming a charge transport layer.

The charge generation layer is dipped in and coated with the coating solution for forming a charge transport layer, and dried at 145° C. for 30 minutes, thereby forming a charge transport layer having an average thickness of 40 μm.

The polyarylate resin (PA1) is a polyarylate resin consisting of the following dicarboxylic acid unit (A2-3) and the following diol unit (B1-2).

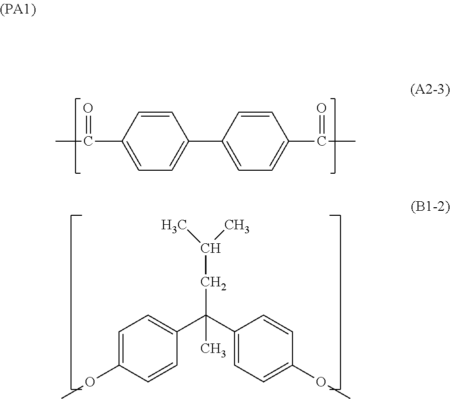

### Photoreceptor (2)

### Formation of Charge Transport Layer

An undercoat layer and a charge generation layer are formed in the same manner as in the photoreceptor (1).

40 parts of a charge transport material N,N′-bis(3-methylphenyl)-N,N′-diphenylbenzidine and 60 parts of a polycarbonate resin (PC1) as a binder resin are dissolved in 270 parts of tetrahydrofuran and 30 parts of toluene to obtain a solution (1). Separately, a mixed solution (2) of 0.02 parts of a fluorine-based comb-shaped graft polymer (trade name: GF-300, TOAGOSEI CO.,LTD.), 5 parts of polytetrafluoroethylene particles (trade name: LUBRON L2, manufactured by Daikin Industries, Ltd.), and 20 parts of tetrahydrofuran is prepared. The solution (1) and the mixed solution (2) are mixed and subjected to a dispersion treatment with a collision-type high-pressure disperser to obtain a coating solution for a charge transport layer.

The charge generation layer is dipped in and coated with the coating solution for a charge transport layer, and dried at 135° C. for 40 minutes, thereby forming a charge transport layer having an average thickness of 40 μm.

A constitutional unit of the polycarbonate resin (PC1) is shown below.

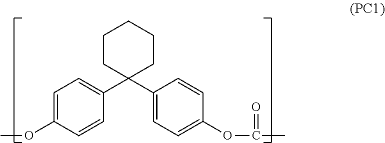

### Production of Charging Roll

### Charging Roll (1)

### Formation of Elastic Layer

Epichlorohydrin rubber (Gechron 3106, ZEON CORPORATION): 100 parts
Carbon black (Asahi #60, ASAHI CARBON CO., LTD.): 6 parts
Calcium carbonate (WHITON SB, Shiraishi Calcium Kaisha, Ltd.): 20 parts
Ion conductive agent (BTEAC, Lion Specialty Chemicals Co., Ltd.): 5 parts
Vulcanization accelerator; stearic acid (NOF Corporation): 1 part
Vulcanization agent; sulfur (VULNOC R, Ouchi Shinko Chemical Industrial Co., Ltd.): 1 part
Vulcanization accelerator; zinc oxide: 1.5 parts

The above-described materials are mixed and kneaded with an open roll. The mixture is subjected to press molding through an adhesive layer on an outer peripheral surface of a shaft (support member) made of SUS303 having a diameter of 8 mm to form an elastic layer. A diameter up to the elastic layer is set to 15 mm. The outer peripheral surface of the elastic layer is polished to obtain a conductive elastic roll having a diameter of 14 mm.

### Formation of Surface Layer

N-methoxymethylated nylon (F30K, Nagase ChemteX Corporation): 85 parts
Polyvinyl butyral (S-LEC BL-1, Sekisui Chemical Co., Ltd.): 15 parts
Carbon black (MONARCH 1000, Cabot Japan Limited): 15 parts
Polyamide particles (Polyamide 12, Arkema Co., Ltd.): 10 parts
Polyether-modified dimethyl polysiloxane (BYK-307, ALTANA AG): 0.05 parts

The above-described materials are mixed, diluted with methanol/1-propanol, and subjected to a dispersion treatment with a beads mill to obtain a coating solution for forming a surface layer. The outer peripheral surface of the conductive elastic roll is dipped in and coated with the coating solution for forming a surface layer in an environment of a temperature of 22° C. and a relative humidity of 50%, and dried at 130° C. for 30 minutes, thereby forming a surface layer having an average thickness of 10 μm.

### Charging Rolls (2) to (16)

A charging roll is produced in the same manner as in the production of the charging roll (1), except that the mass proportion of the polyvinyl butyral in the binder resin (the N-methoxymethylated nylon and the polyvinyl butyral), the addition amount of the silicon compound (the polyether-modified dimethyl polysiloxane, BYK-307, ALTANA AG), and/or the temperature and humidity when the outer peripheral surface of the conductive elastic roll is dipped in and coated with the coating solution for forming a surface layer are changed as shown in Table 2.

### Examples 1 to 14 and Comparative Examples 1 to 3: Production of Image Forming Unit

The photoreceptor (1) or (2) and any one of the charging rolls (1) to (16) are set as a set in combination shown in Table 2, and formed into an image forming unit.

### Performance Evaluation

### Fogging

The image forming unit including the photoreceptor and the charging roll is mounted on a black image forming unit of an image forming apparatus ApeosPrint C3560 S (FUJIFILM Business Innovation Corporation), and evaluation is performed using this image forming apparatus.

An image having an image density of 0% (that is, a blank paper) is output to A4-sized plain paper in an environment of a temperature of 10° C. and a relative humidity of 15%. A density of one center portion of the unprinted paper and the printed paper is measured using X-Rite 404A densitometer. A difference in density between the two is classified as follows. Table 2 shows the evaluation results.
G0: difference in density is 0.00, and fogging does not occur.
G1: difference in density is 0.01 or less, and very slight fogging occurs.
G2: difference in density is more than 0.01 and less than 0.03, and slight fogging occurs (no problem in practical use).
G3: difference in density is 0.03 or more, and obvious fogging occurs (that is problems in practical use).

### Streak-Like Density Unevenness

A vibration test and a drop test simulating product transportation are performed on the image forming unit, and then image formation is performed. The vibration test and the drop test are tests in which the photoreceptor and the charging roll are rubbed with each other so that the photoreceptor is charged.

### Vibration Test

The photoreceptor and the charging roll are assembled in a process cartridge of an image forming apparatus ApeosPrint C3560 S (FUJIFILM Business Innovation Corporation). The process cartridge is individually packaged in a form as shipment. The individual package (that is a rectangular parallelepiped) is placed on a vibration table of a vibration tester (Shinken co., Ltd., G-9223LS type) with one of the surfaces having the maximum area as a bottom surface, and metal blocks are placed on four sides of the bottom surface so that the individual package is not moved on the vibration table. A vibration test in which all of vibration conditions (i) to (iii) shown in Table 1 are applied to the individual package in this order is performed.

TABLE 1

| | Vibration | Vibration | | | | Vibration |
|---|---|---|---|---|---|---|
| | type | direction | Frequency | Sweep ratio | Acceleration | time |
| (i) | A | Vertical | 3 Hz → 100 Hz → 3 Hz | 0.3 Hz/sec | 6.9 m/sec\hat{ }2 (constant) | 10 min |
| (ii) | B | Vertical | Resonant frequency (fixed) | — | 6.9 m/sec\hat{ }2 (constant) | 20 min |
| (iii) | C | Vertical | Mode A | Mode B | Mode C | 20 minutes for |

| | | | | | | |
|---|---|---|---|---|---|---|
| Hz | G\hat{ }2/Hz | Hz | G\hat{ }2/Hz | Hz | G\hat{ }2/Hz | each mode |
| 1 | 0.00005 | 1 | 0.00001 | 2 | 0.0002 | total: 60 |
| 4 | 0.01 | 2 | 0.001 | 12 | 0.01 | minutes |
| 16 | 0.01 | 50 | 0.001 | 100 | 0.01 | |
| 40 | 0.001 | 90 | 0.0004 | 300 | 0.00001 | |
| 80 | 0.001 | 200 | 0.00001 | | | |
| 200 | 0.00001 | | | | | |

| | | |
|---|---|---|
| 0.52 Grms | 0.29 Grms | 1.05 Grms |

### Drop Test

After performing the vibration test, the individual package (that is a rectangular parallelepiped) is allowed to freely fall from a height of 1 m onto an iron plate a total of 10 times in the following order of (1) to (3). Here, the height is a distance from the lowest portion of the individual package to the upper surface of the iron plate.
(1) Each surface of the rectangular parallelepiped is dropped once, and the surfaces are aligned in the horizontal direction, and then the rectangular parallelepiped is dropped a total of 6 times.
(2) One diagonal line is aligned with the gravity direction, one vertex is directed downward, and the rectangular parallelepiped is dropped once.
(3) Each of three sides extending from one corner is dropped once, a plane dividing the rectangular parallelepiped into two equal parts with a side in the horizontal direction and a diagonal line is aligned with the gravity direction, and the rectangular parallelepiped is dropped three times in total.

### Image Formation

After performing the vibration test and the drop test on the individual package, the process cartridge is taken out from the packaging and mounted on a black image forming unit of an image forming apparatus ApeosPrint C3560 S (FUJIFILM Business Innovation Corporation), and evaluation is performed using this image forming apparatus.

In an environment of a temperature of 22° C. and a relative humidity of 55%, a black halftone image having an image density of 30% is output. The black halftone image is visually observed, and the streak-like density unevenness is classified as follows.

Table 2 shows the evaluation results.

A: no streak-like density unevenness is observed.

B: slight streak-like density unevenness is observed, but there is no problem in practical use.

C: streak-like density unevenness is observed, that is a problem in practical use.

TABLE 2

| | | Charging Roll | | | | | | | | | |
|---|---|---|---|---|---|---|---|---|---|---|---|
| | | | | | | | Temperature and | | | Image | |
| | | | Polyvinyl | Dimethyl | | | humidity during dip | | | | Streak-like |
| | | | butyral | polysiloxane | | Si | coating | | | | density |
| | Photoreceptor | | Mass | Addition | | concentration | | Relative | RzJIS | Fogging | unevenness |
| | Number | Number | proportion | amount | | atm % | Temperature | humidity | μm | Grade | Grade |
| Comparative | (2) | (1) | 15% | 0.05 | parts | 0.30 | 22° C. | 50% | 5.4 | G0 | C |
| Example 3 | | | | | | | | | | | |
| Comparative | (1) | (2) | 15% | 0.01 | parts | 0.10 | 22° C. | 50% | 6.7 | G3 | A |
| Example 1 | | | | | | | | | | | |
| Example 2 | (1) | (3) | 15% | 0.035 | parts | 0.20 | 22° C. | 50% | 5.7 | G1 | A |
| Example 3 | (1) | (4) | 15% | 0.04 | parts | 0.24 | 22° C. | 50% | 5.5 | G1 | A |
| Example 1 | (1) | (1) | 15% | 0.05 | parts | 0.30 | 22° C. | 50% | 5.4 | G0 | A |
| Example 4 | (1) | (5) | 15% | 0.18 | parts | 1.10 | 22° C. | 50% | 5.2 | G0 | B |
| Example 5 | (1) | (6) | 15% | 0.2 | parts | 1.20 | 22° C. | 50% | 5.2 | G0 | B |
| Comparative | (1) | (7) | 15% | 0.3 | parts | 1.50 | 22° C. | 50% | 5.4 | G0 | C |
| Example 2 | | | | | | | | | | | |
| Example 6 | (1) | (8) | 5% | 0.05 | parts | 0.30 | 22° C. | 50% | 5.1 | G2 | A |
| Example 7 | (1) | (9) | 10% | 0.05 | parts | 0.30 | 22° C. | 50% | 5.2 | G1 | A |
| Example 8 | (1) | (10) | 30% | 0.05 | parts | 0.30 | 17° C. | 50% | 5.8 | G1 | A |
| Example 9 | (1) | (11) | 31% | 0.05 | parts | 0.30 | 17° C. | 50% | 5.9 | G2 | A |
| Example 10 | (1) | (12) | 15% | 0.035 | parts | 0.20 | 24° C. | 50% | 5.9 | G1 | A |
| Example 11 | (1) | (13) | 15% | 0.035 | parts | 0.20 | 28° C. | 50% | 6.0 | G2 | A |
| Example 12 | (1) | (14) | 15% | 0.16 | parts | 1.00 | 22° C. | 50% | 5.2 | G0 | A |
| Example 13 | (1) | (15) | 20% | 0.05 | parts | 0.30 | 22° C. | 50% | 5.5 | G0 | A |
| Example 14 | (1) | (16) | 20% | 0.16 | parts | 1.00 | 22° C. | 50% | 5.3 | G0 | A |

The image forming unit, the process cartridge, and the image forming apparatus according to the present disclosure include the following aspects.

### Supplementary Note

(((1))

An image forming unit comprising:
a photoreceptor; and
a charging member that comes into contact with a surface of the photoreceptor to charge the photoreceptor,
wherein the photoreceptor includes a conductive substrate and a lamination-type photosensitive layer that has a charge generation layer and a charge transport layer disposed on the conductive substrate,
the charge transport layer contains a polyarylate resin and does not substantially contain an organic fluorine compound,
the charging member includes a support member, an elastic layer disposed on the support member, and a surface layer disposed on the elastic layer, and
the surface layer contains a resin, conductive particles, and a silicon compound, and a silicon element concentration on a surface of the surface layer is 0.2 atm % or more and 1.2 atm % or less.
   (((2)))

The image forming unit according to (((1)

wherein the silicon element concentration on the surface of the surface layer is 0.3 atm % or more and 1.0 atm % or less.

(((3)))

The image forming unit according to (((1))) or (((2))),

wherein the surface layer of the charging member contains, as a binder resin, a polyamide resin and a polyvinyl butyral resin, and a proportion of the polyvinyl butyral resin in a total amount of the polyamide resin and the polyvinyl butyral resin is 10% by mass or more and 30% by mass or less.

(((4)))

The image forming unit according to (((3))),

wherein the proportion of the polyvinyl butyral resin in the total amount of the polyamide resin and the polyvinyl butyral resin is 15% by mass or more and 20% by mass or less.

(5)

The image forming unit according to any one of (((1))) to (((4))),

wherein a ten-point average roughness RzJIS (JIS B 0601:2013) of an outer peripheral surface of the charging member is 5.9 μm or less.

(((6)))

A process cartridge comprising:
the image forming unit according to any one of (((1))) to (((5))),
wherein the process cartridge is attachable to and detachable from an image forming apparatus.
   (((7)))

An image forming apparatus comprising:
the image forming unit according to any one of (((1))) to (((5)));
an electrostatic latent image forming device that forms an electrostatic latent image on a charged surface of the photoreceptor;
a developing device that develops the electrostatic latent image formed on the surface of the photoreceptor with a developer containing a toner to form a toner image; and
a transfer device that transfers the toner image to a surface of a recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming unit comprising:
a photoreceptor; and
a charging member that comes into contact with a surface of the photoreceptor to charge the photoreceptor,
wherein the photoreceptor includes a conductive substrate and a lamination-type photosensitive layer that has a charge generation layer and a charge transport layer disposed on the conductive substrate,
the charge transport layer contains a polyarylate resin and does not substantially contain an organic fluorine compound,
the charging member includes a support member, an elastic layer disposed on the support member, and a surface layer disposed on the elastic layer, and
the surface layer contains a resin, conductive particles, and a silicon compound, and a silicon element concentration on a surface of the surface layer is 0.2 atm % or more and 1.2 atm % or less.

2. The image forming unit according to claim 1,
wherein the silicon element concentration on the surface of the surface layer is 0.3 atm % or more and 1.0 atm % or less.

3. The image forming unit according to claim 1,
wherein the surface layer of the charging member contains, as a binder resin, a polyamide resin and a polyvinyl butyral resin, and a proportion of the polyvinyl butyral resin in a total amount of the polyamide resin and the polyvinyl butyral resin is 10% by mass or more and 30% by mass or less.

4. The image forming unit according to claim 3,
wherein the proportion of the polyvinyl butyral resin in the total amount of the polyamide resin and the polyvinyl butyral resin is 15% by mass or more and 20% by mass or less.

5. The image forming unit according to claim 1,
wherein a ten-point average roughness RzJIS (JIS B 0601:2013) of an outer peripheral surface of the charging member is 5.9 μm or less.

6. A process cartridge comprising:
the image forming unit according to claim 1,
wherein the process cartridge is attachable to and detachable from an image forming apparatus.

7. A process cartridge comprising:
the image forming unit according to claim 2,
wherein the process cartridge is attachable to and detachable from an image forming apparatus.

8. A process cartridge comprising:
the image forming unit according to claim 3,
wherein the process cartridge is attachable to and detachable from an image forming apparatus.

9. A process cartridge comprising:
the image forming unit according to claim 4,
wherein the process cartridge is attachable to and detachable from an image forming apparatus.

10. A process cartridge comprising:
the image forming unit according to claim 5,
wherein the process cartridge is attachable to and detachable from an image forming apparatus.

11. An image forming apparatus comprising:
the image forming unit according to claim 1;
an electrostatic latent image forming device that forms an electrostatic latent image on a charged surface of the photoreceptor;
a developing device that develops the electrostatic latent image formed on the surface of the photoreceptor with a developer containing a toner to form a toner image; and
a transfer device that transfers the toner image to a surface of a recording medium.

12. An image forming apparatus comprising:
the image forming unit according to claim 2;
an electrostatic latent image forming device that forms an electrostatic latent image on a charged surface of the photoreceptor;
a developing device that develops the electrostatic latent image formed on the surface of the photoreceptor with a developer containing a toner to form a toner image; and
a transfer device that transfers the toner image to a surface of a recording medium.

13. An image forming apparatus comprising:
the image forming unit according to claim 3;
an electrostatic latent image forming device that forms an electrostatic latent image on a charged surface of the photoreceptor;
a developing device that develops the electrostatic latent image formed on the surface of the photoreceptor with a developer containing a toner to form a toner image; and
a transfer device that transfers the toner image to a surface of a recording medium.

14. An image forming apparatus comprising:
the image forming unit according to claim 4;
an electrostatic latent image forming device that forms an electrostatic latent image on a charged surface of the photoreceptor;
a developing device that develops the electrostatic latent image formed on the surface of the photoreceptor with a developer containing a toner to form a toner image; and
a transfer device that transfers the toner image to a surface of a recording medium.

15. An image forming apparatus comprising:
the image forming unit according to claim 5;
an electrostatic latent image forming device that forms an electrostatic latent image on a charged surface of the photoreceptor;
a developing device that develops the electrostatic latent image formed on the surface of the photoreceptor with a developer containing a toner to form a toner image; and
a transfer device that transfers the toner image to a surface of a recording medium.
